(19) United States
(12) Patent Application Publication
(10) Pub. No.: US 2005/0281299 A1
(43) Pub. Date: Dec. 22, 2005

(54) Semiconductor laser element and method of manufacturing the same

(75) Inventor: Takahiro Hashimoto, Yamatokoriyama-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/158,507

(22) Filed: Jun. 21, 2005

(30) Foreign Application Priority Data
Jun. 22, 2004 (JP) JP2004-183785

(51) Int. Cl. H01S 3/04

(52) U.S. Cl. 372/34

(57) ABSTRACT

Provided is a semiconductor laser element depositing an insulating film on a p-type cladding layer in which it is possible to prevent bulk deterioration of the semiconductor laser element by suppressing thermal stress caused on a p-type cladding layer. A compound semiconductor multilayer structure is formed by depositing an n-type cladding layer, an active layer and a p-type cladding layer having a ridge part formed thereon sequentially in a deposition direction. Then, deposited in the deposition direction of the compound semiconductor structure is an insulating film formed of an insulating material which has a refractive index different from that of a material constituting the p-type cladding layer and a thermal expansion coefficient approximate to that of a material constituting the p-type cladding layer.

### BACKGROUND OF THE INVENTION

1. Field of the Invention

The present invention relates to a semiconductor laser element and a method of manufacturing the semiconductor laser element.

2. Description of the Related Art

In recent years, increase in output of laser beams to be emitted from semiconductor laser elements and decrease in operating current of semiconductor lasers have been desired in apparatuses in which semiconductor laser elements are used, such as optical pickups and the like. A ridge waveguide semiconductor laser element, a so-called real refractive index waveguide type laser element is provided as a semiconductor laser element which meets such requirements.

FIG. 7 is a cross sectional view showing schematically a semiconductor laser element 100 of a related art. The semiconductor laser element 100 is a ridge waveguide semiconductor element, which is formed such that an n-type buffer layer 102, an n-type cladding layer 103, an active layer 104 and a p-type cladding layer 105 are deposited sequentially in one direction on an n-type substrate 101. On the p-type cladding layer 105, a protruding part 106 is formed which is shaped in a stripe and protrudes in the one direction. A capping layer 107 is formed on a surface part facing the one direction of the protruding part 106. A ridge part 108 is constituted by the protruding part 106 and the capping layer 107. Further, a protective layer 109 is deposited on a surface part facing the one direction of the p-type cladding layer 105 and both surface parts in the width direction of the ridge part 108. The protective layer 109 is an insulating thin film formed of silicon oxide and silicon nitride. On the surface part facing the one direction of the capping layer 107, a p-type ohmic electrode 110 is formed. A die-bonding electrode 111 is formed on the p-type ohmic electrode 110 and the protective layer 109 so as to cover them. Furthermore, an n-type ohmic electrode 112 is formed in a surface part facing a direction opposite to the one direction of the n-type substrate 101, and moreover, a wire bonding electrode 113 is formed so as to cover the n-type ohmic electrode 112.

FIGS. 8A to 8I are drawings showing sequentially manufacturing processes of the semiconductor laser element 100. As shown in FIG. 8A, by means of a metal organic chemical vapor deposition process (MOCVD process) an n-type buffer layer 102, an n-type cladding layer 103, an active layer 104, a p-type cladding layer 105 and a capping layer 107 are deposited sequentially in one direction on an n-type substrate 101. Next, as shown in FIG. 8B, a stripe-shaped ridge part 108 is formed by etching toward another direction of the capping layer 107. Further, as shown in FIG. 8C, a protective layer 109 is deposited so as to cover the p-type cladding layer 105 and the ridge part 108. Next, as shown in FIG. 8D, a photoresist film 114 is formed on the protective layer 109, and as shown in FIG. 8E, the photoresist formed on an upper surface part of the ridge part 108 is removed, thereby causing the protective film 109 formed on the upper surface part of the ridge part 108 to be exposed. Hereto, the upper surface part is a surface part facing the one direction. Then, as shown in FIG. 8F, the exposed protective film 109 is removed to cause the upper surface part of the ridge part 108 to be exposed. As shown in FIG. 8G, a p-type ohmic electrode 110 is formed on the photoresist film 114 and the upper surface part of the ridge part 108, and an n-type ohmic electrode 112 is formed on a surface part facing another direction of the n-type substrate 101. Furthermore, as shown in FIG. 8H, the portion of the p-type ohmic electrode 110 excluding that formed on the upper surface part of the ridge part 108 is removed. Finally, as shown in FIG. 8I, a die-bonding electrode 111 is formed so as to cover the protective film 109 and the p-type ohmic electrode 110 and a wire bonding electrode 113 is formed so as to cover the n-type ohmic electrode 112. Thereby, the semiconductor laser element 100 can be constituted.

In the semiconductor laser element 100 thus constituted, an electric current is flowed through the ridge part 108 only. Accordingly, even in the case of a low electric current, electrons to be injected can be concentrated into the lower part of the ridge part 108, thereby enabling the semiconductor laser element 100 to emit a high-power laser beam (for example, see Japanese Unexamined Patent Publication JP-A 2002-94181 (pages 4 and 5, FIGS. 1 and 2)).

The semiconductor laser element 100 of the related art can be operated at low currents and can output a high-power laser beam. The semiconductor laser element 100 emits such a high-power laser beam, and further generates heat caused by nonradiative recombination inside the semiconductor laser element 100. Therefore, in the semiconductor laser element 100, each layer gives rise to thermal expansion and thermal stress is caused. In the semiconductor laser element 100, the p-type cladding layer 105 is formed of a material having a high thermal expansion coefficient of aluminum arsenide (AlAs) and gallium arsenide (GaAs), and the protective film is formed of a material having a low thermal expansion coefficient such as silicon oxide. In the p-type cladding layer 105, when formed in this way, thermal stress occurs and its resultant strain and crystal defects occur in the active layer. This results in increasing nonradiative recombination, thereby causing bulk deterioration. The bulk deterioration inhibits laser beam emission. For this reason, in the above-described semiconductor laser element 100, the laser beam emission lifetime of the semiconductor laser element 100 is short.

### SUMMARY OF THE INVENTION

An object of the invention is to provide a semiconductor laser element which is capable of preventing bulk deterioration of the semiconductor laser element by suppressing thermal stress caused on a p-type cladding layer in a semiconductor laser element in which an insulating film is deposited on a p-type cladding layer.

The invention provides a semiconductor laser element comprising:

a compound semiconductor multilayer structure composed of at least a first cladding layer of a first conductivity type, an active layer, and a second cladding layer of a second conductivity type, which layers are deposited sequentially in one direction, the second cladding layer including a ridge part shaped in a stripe; and

an insulating film formed of an insulating material having a refractive index different from that of a material constituting the second cladding layer and a thermal expansion coefficient approximate to that of a material constituting the second cladding layer,

wherein the insulating film is deposited on the second cladding layer.

According to the invention, it-is possible to constitute a compound semiconductor multilayer structure in which a first cladding layer of a first conductivity type, an active layer and a second cladding layer of a second conductivity type are deposited sequentially. The second cladding layer includes a ridge part shaped in a stripe. With this configuration, a laser beam can be emitted from the compound semiconductor multilayer structure. Further, an insulating film formed of an insulating material is deposited on the second cladding layer. Since the insulating film is formed of an insulating material, electro-current constriction is made possible so that holes are injected in desired positions in the second cladding layer. In this way, it is possible to concentrate holes into the desired positions of the second cladding layer. The insulating material has a refractive index different from that of a material constituting the second cladding layer. Thus, a laser beam which is guided in a compound semiconductor multilayer structure can be confined to the second cladding layer. Furthermore, the insulating material has a thermal expansion coefficient approximate to that of a material constituting the second cladding layer. This enables decreasing a difference in thermal expansion amount between the insulating film and the second cladding layer, and thereby it is possible to prevent thermal stress of the second cladding layer from occurring due to this thermal expansion difference.

According to the invention, the insulating film is capable of concentrating holes acting as carriers on the desired positions in the second cladding layer, and is capable of confining a laser beam which is guided inside the semiconductor laser element. Thereby, the semiconductor laser element can be operated at low electric currents and can emit a high-power laser beam. Since the thermal expansion coefficient of the insulating film is approximate to that of the second cladding layer, it is possible to prevent thermal stress which acts on the second cladding layer due to a difference in thermal expansion. In this way, the thermal stress which acts on the second cladding layer can be prevented, thereby preventing strain and crystal defects of the active layer from occurring due to the thermal stress. Such strain and crystal defects may cause nonradiative recombination resulting in generating a heat. By preventing strain and crystal defects from occurring in the active layer, it is made possible to prevent nonradiative recombination in the active layer. In other words, the production, proliferation and transfer centering on nonradiative recombination can be prevented and the bulk deterioration involved can be prevented. With the prevention of the bulk deterioration, it is possible to prevent the occurrence of a dark region (Dark Region: abbreviated to DR) and a dark line defect (DarkLine Defect: abbreviated to DLD) due to the bulk deterioration.

In the invention, it is preferable that the insulating material is an alumina film.

According to the invention, alumina is used as an insulating material. Alumina, having insulation properties, is a material having a refractive index different from and a thermal expansion coefficient approximate to those of a material constituting the second cladding layer. The insulating film is realized by using alumina.

According to the invention, the insulating film is realized by using alumina as an insulating material. That is to say, it is possible to emit a high-power laser beam which can be operated at low electric currents and to realize a semiconductor laser element which can prevent DR and DLD from occurring due to bulk deterioration.

In the invention, it is preferable that the insulating film has a film thickness of 100 nm or more. and 300 nm or less.

According to the invention, an insulating film having a film thickness of 100 nm or more and 300 nm or less is deposited on the second cladding layer. This can prevent the insulating film from peeling off the second cladding layer.

According to the invention, when the film thickness of the insulating film is 100 nm or more and 300 nm or less, it is possible to prevent the insulating film from peeling off at the interface with the second cladding layer. The insulating film can thus be deposited securely on the second cladding layer. Accordingly, this can ensure the predetermined effect that is accomplished by depositing the insulating film on the second cladding layer.

In the invention, it is preferable that the semiconductor laser further comprises a protective film deposited on the insulating film, for relaxing thermal stress which acts on the second cladding layer.

According to the invention, a protective film is deposited on the insulating film. The protective film relaxes thermal stress which acts on the second cladding layer. It is possible to relax thermal stress which acts on the second cladding layer due to the deposition of the insulating film on the second cladding layer. Accordingly, thermal stress which acts on the second cladding layer can be further reduced.

According to the invention, the protective film can relax thermal stress which acts on the second cladding layer. Since the thermal stress which acts on the second cladding layer can thus be relaxed, it is possible to prevent the occurrence of strain and crystal defects of the active layer due to thermal stress, and thereby preventing the production, proliferation and transfer of a nonradiative recombination center. This can further prevent bulk deterioration arising from the production, proliferation and transfer of nonradiative recombination center and can further prevent DR and DLD from occurring due to bulk deterioration, as compared with the case where only the insulating film is deposited.

In the invention, it is preferable that the protective film is formed of one of silicon oxide, silicon nitride and silicon.

According to the invention, the protective film is formed of one material of silicon oxide, silicon nitride and silicon. This can realize a protective layer for relaxing thermal stress of the second cladding layer which is caused by the insulating film.

According to the invention, the protective film can be realized by using one of silicon oxide, silicon nitride and silicon. As compared with the case where only the insulating film is deposited, it is possible to realize the semiconductor laser element which is capable of further preventing DR and DLD from occurring due to bulk deterioration.

In the invention, it is prefereble that the protective film has a film thickness of 100 nm or more and 300 nm or less.

According to the invention, the protective film having a film thickness of 100 nm or more and 300 nm or less is deposited on the second cladding layer. This can prevent the protective film from peeling off the insulating film.

According to the invention, it is possible to prevent the protective film from peeling off at the interface with the insulating film. This prevents the protective film and the insulating film from being spaced to each other and enables the protective film to be deposited securely. It is, therefore, possible to obtain securely the predetermined effect that is accomplished by depositing the protective film on the insulating film.

Further, the invention provides a method of manufacturing a semiconductor laser element comprising:

a compound semiconductor multilayer structure manufacturing step of depositing a first cladding layer of a first conductivity type, an active layer and a second cladding layer of a second conductivity type, sequentially in one direction, and forming a ridge part shaped in a stripe on the second cladding layer; and

an insulating film forming step of forming an insulating film on the second cladding layer by depositing an insulating material having a refractive index different from that of a material constituting the second cladding layer and a thermal expansion coefficient approximate to that of a material constituting the second cladding layer.

According to the invention, in a compound semiconductor multilayer structure manufacturing step, the compound semiconductor multilayer structure is constituted by depositing sequentially a first cladding layer of a first conductivity type, an active layer and a second cladding layer of a second conductivity type. In this way, it is possible to constitute a compound semiconductor multilayer structure which is capable of emitting a laser beam. In an insulating film forming step, an insulating film is formed on the second cladding layer by depositing an insulating material having a refractive index different from that of a material constituting the second cladding layer and a thermal expansion coefficient approximate to that of a material constituting the second cladding layer. By manufacturing through the above steps, it is possible to manufacture a semiconductor laser element in which the above-described insulating film is deposited on the compound semiconductor multilayer structure.

According to the invention, since the insulating film is deposited on the second cladding layer, holes can be concentrated into the desired positions in the second cladding layer. Accordingly, it is possible to manufacture a semiconductor laser element which can confine a laser beam being guided inside the semiconductor laser element. In this way, a high-power laser beam can be generated at low electric currents, by concentrating holes acting as carriers and confining a laser beam being guided. That is to say, by means of the semiconductor laser element manufacturing method, the semiconductor laser element which is capable of generating a high-power laser beam at low electric currents can be manufactured. Furthermore, in the semiconductor laser element manufactured according to the invention, the insulating film has a thermal expansion coefficient approximate to that of a material constituting the second cladding layer. Accordingly, it is possible to prevent thermal stress which acts on the second cladding layer. Thus, by preventing thermal stress which acts on the second cladding layer, it is possible to prevent bulk deterioration incident to the thermal stress and to prevent the occurrence of DR and DLD due to bulk deterioration. That is to say, by means of the semiconductor laser element manufacturing method, it is possible to manufacture a semiconductor laser element which is capable of preventing the occurrence of DR and DLD.

In the invention, it is preferable that the method further comprises a protective film forming step of depositing on the insulating film a protective film for relaxing thermal stress which acts on the second cladding layer.

According to the invention, in the protective film forming step, a protective film for relaxing thermal stress which acts on the second cladding layer is deposited on the insulating film. In this way, it is possible to manufacture a semiconductor laser element which is capable of relaxing thermal stress which acts on the second cladding layer.

According to the invention, it is possible to manufacture a semiconductor laser element which is capable of relaxing thermal stress which acts on the second cladding layer by means of the protective layer. This enables the semiconductor laser element to prevent bulk deterioration incident to the thermal stress and further prevent the occurrence of DR and DLD due to the bulk deterioration. That is to say, it is possible to manufacture a semiconductor laser element in which DR and DLD can be further prevented.

### BRIEF DESCRIPTION OF THE DRAWINGS

Other and further objects, features, and advantages of the invention will be more explicit from the following detailed description taken with reference to the drawings wherein:

FIG. 1 is a cross sectional view showing schematically a semiconductor laser element according to an embodiment of the invention;

FIG. 2 is a flow chart showing simplistically the steps of manufacturing a semiconductor laser element;

FIG. 3 is a flow chart showing the steps of manufacturing the semiconductor laser element;

FIGS. 4A to 4J are views showing schematically the steps of manufacturing the semiconductor laser element;

FIGS. 5A and 5B are views showing schematically the stress relationship between an insulating film, a protective film and a p-type cladding layer, by enlarging a part of the semiconductor laser element;

FIGS. 6A to 6C are graphs showing FFPs of laser beams emitted;

FIG. 7 is a cross sectional view showing schematically a semiconductor laser element of the related art; and

FIGS. 8A to 8I are views showing sequentially manufacturing steps of the semiconductor laser element.

### DETAILED DESCRIPTION

Now referring to the drawings, preferred embodiments of the invention are described below.

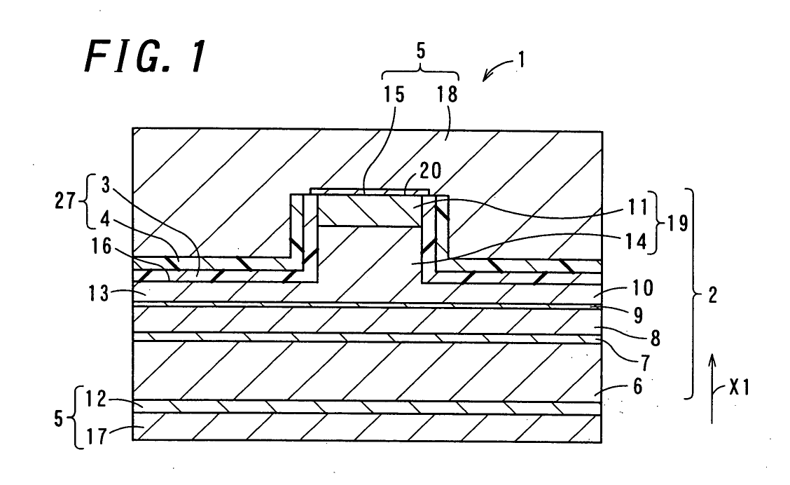

FIG. 1 is a cross sectional view showing schematically a semiconductor laser element 1 according to an embodiment of the invention. The semiconductor laser element 1 is a real refractive index waveguide type semiconductor laser element and is constituted such that a laser beam can be emitted. The semiconductor laser element 1 is used, for example, in an optical pickup and the like. The semiconductor laser element 1 is configured in a substantially rectangular parallelepiped. However, the shape of the semiconductor laser element 1 is not limited to a substantially rectangular parallelepiped. The semiconductor laser element 1 comprises a compound semiconductor multilayer structure 2, an insulating film 3, a protective film 4 and an electrode 5.

The compound semiconductor multilayer structure 2 comprises an n-type substrate 6, an n-type buffer layer 7, an n-type cladding layer 8, an active layer 9, a p-type cladding layer 10 and p-type capping layer 11. Each of the n-type substrate 6, the n-type buffer layer 7, the n-type cladding layer 8 and the active layer 9 is formed in a substantially plate-like shape and is formed such that its cross section seen as cut by a virtual plane perpendicular to a thickness direction thereof has a substantially rectangular shape.

The n-type substrate 6 is constituted so as to be capable of causing growth of a semiconductor crystal on a surface part facing one side of the thickness direction thereof. Further, the n-type substrate 6 is constituted so as to permit making an ohmic contact with an n-type ohmic electrode 12 contained in the electrode 5. In this embodiment, the n-type substrate 6 is formed of an n-type gallium arsenide (hereinafter, simply referred to as “n-GaAs”, occasionally) in which n-type corresponds to a first conductivity type. The n-type buffer layer 7 is constituted such that it is possible to prevent the n-type substrate 6 and the n-type cladding layer 8 from peeling off at the interface thereof. That is to say, the n-type buffer layer 7 is constituted so as to protect the n-type substrate 6 and the n-type cladding layer 8 from lattice relaxation, and is formed, for example, by an n-type semiconductor whose lattice constant is greater than that of the n-type substrate 6 and smaller than that of the n-type cladding layer 8. In this embodiment, the n-type buffer layer 7 is formed of gallium arsenide.

The n-type cladding layer 8 as a first cladding layer is formed of an n-type semiconductor which has a larger forbidden band and a lower refractive index than those of the active layer 9. In this embodiment, the n-type cladding layer 8 is formed of n-type aluminum gallium arsenide which is represented by n-Al_{0.5}Ga_{0.5}As. As shown in Table 1, gallium arsenide has a thermal expansion coefficient of 6.9×10⁻⁶/K. Aluminum arsenide has a thermal expansion coefficient of 5.2×10⁻⁶/K. Further, aluminum gallium arsenide has a refractive index of 3.61 when about 3% of aluminum arsenide is contained as mixed crystal, and has a refractive index of 3.56 when about 13% of aluminum arsenide is contained as mixed crystal.

TABLE 1

| | Thermal | |
|---|---|---|
| | expansion | |
| | coefficient | |
| Material | (10⁻⁶/K) | Refractive index |
| Alumina | 8.6 | 1.75 |
| Silicon oxide | 0.5 | 1.46 |
| Silicon nitride | 2.8 | 2.05 |
| Gallium arsenide | 6.9 | 3.61 |
| | | (850 nm band, |
| | | small aluminum |
| | | mixed crystal ratio) |
| Aluminum arsenide | 5.2 | 3.56 |
| | | (780 nm band, |
| | | large aluminum |
| | | mixed crystal ratio) |
| Silicon | 2.6 | 3.4 |

The active layer 9 is formed of a material which has a smaller forbidden band than that of each of other layers constituting the compound semiconductor multi layer structure 2. The active layer 9 is constituted so that electrons and holes acting as carriers can be injected therein. Since the active layer 9 is thus constituted such that the forbidden band thereof is smaller than that of each of other layers and such that electrons and holes can be injected, the active layer 9 is constituted so as to be able to confine the carriers to the active layer 9. Furthermore, the active layer 9 is constituted such that a laser beam can be generated by recombining radiatively the electrons and holes injected and can be guided inside the active layer 9. In this embodiment, the active layer 9 is formed of aluminum gallium arsenide (hereinafter, simply referred to as “AlGaAs”, occasionally).

The p-type cladding layer 10 as a second cladding layer comprises a plate-like part 13 whose cross section seen as cut by a virtual plane perpendicular to the thickness direction thereof has a substantially rectangular shape, and a convex steak part 14 protruding on one side of the thickness direction of the plate-like part 13. The plate-like part 13 is formed so as to have substantially the same shape of cross section as that of the active layer 9. The convex streak part 14 is shaped in a stripe and disposed in the intermediate portion of the width direction in one surface part of the thickness direction of the plate-like part 13. The convex streak part 14 is formed ranging from one end to another end of the longitudinal direction of the plate-like part 13, and is formed so that its cross section seen as cut by a virtual plane perpendicular to the protruding direction thereof has a rectangular shape. Note, however, that the convex streak part 14 is not limited to the shape thus far described. The p-type cladding layer 10 is formed by a p-type semiconductor of a second conductivity type which has a larger forbidden band and a lower refractive index than those of the active layer 9. In this embodiment, the p-type cladding layer 10 is formed of p-type aluminum gallium arsenide which is represented by p-Al_{0.5}Ga_{0.5}As.

The p-type capping layer 11 is formed in a plate-like shape. The p-type capping layer 11 is formed such that its cross section seen as cut by a virtual plane perpendicular to the thickness direction thereof has a rectangular shape and such that the shape of the cross section is substantially the same as that of the cross section seen as cut by a virtual plane perpendicular to the protruding direction of the convex streak part 14. The p-type capping layer 11 is constituted so as to permit making an ohmic contact with a p-type ohmic electrode 15 contained in the electrode 5. In this embodiment, the p-type capping layer 11 is formed of p-type aluminum gallium arsenide (hereinafter, simply referred to as “AlGaAs”, occasionally).

An insulating film 3 is constituted so as to be coated on a surface part excluding a part of one surface part of the p-type cladding layer 10. The one surface part of the p-type cladding layer 10 is one surface part in the thickness direction thereof and a surface part on the side on which the convex streak part 14 is formed. More specifically, the insulating film 3 is formed so as to cover a non-formed surface part 16 of the plate-like part 13 and both surface parts in the width direction of the convex streak part 14. The non-formed surface part 16 is one surface part of the plate-like part 13 and is a part on which the convex streak part 14 is not formed. The insulating film 3 is formed of an insulating material which has a lower refractive index than that of the p-type cladding layer 10 and a thermal expansion coefficient approximate to that of the p-type cladding layer 10. The language “approximate” is synonymous with a language “substantially the same”, and the meaning of the language “substantially the same” contains the meaning of a language “the same”. Specifically, it is preferred that the difference in thermal expansion coefficient between the insulating film 3 and the p-type cladding layer 10 is 3×10⁻⁶/K or less. Further, the insulating film 3 is formed of an insulating material capable of causing growth of a crystal constituting the protective film 4 on a protective film depositing surface part opposite to a coating surface part with respect to the thickness direction thereof. The coating surface part is one surface part in the thickness direction of the insulating film 3 and is a surface part opposed to the p-type cladding layer 10. Further, the insulating film 3 is deposited on the p-type cladding layer 10 through crystal growth. In a case where the insulating film 3 has a higher film thickness, the insulating film 3 peels off the p-type cladding layer 10. Accordingly, the insulating film 3 is formed thinly. It is preferred that the insulating film 3 is formed so as to have a film thickness 100 nm or more and 300 nm or less. In this embodiment, an insulating material constituting the insulating film 3 is aluminum oxide (hereinafter, simply referred to as “alumina”, occasionally) . As shown in Table 1, the refractive index of alumina is 1.75, and the thermal expansion coefficient of alumina is 8.6×10⁻⁶/K.

The protective film 4 is formed so as to be capable of covering the protective film depositing surface part of the insulating film 3. The protective film 4 is constituted so as to be capable of relaxing thermal stress applied to the p-type cladding layer 10. Specifically, in a case where the insulating film 3 has a higher thermal expansion coefficient than that of the p-type cladding layer 10, the protective film 4 is formed of an insulating material having a lower thermal expansion coefficient than that of the insulation film 3. On the other hand, in a case where the insulating film 3 has a lower thermal expansion coefficient than that of the p-type cladding layer 10, the protective film 4 is formed of an insulating material having a higher thermal expansion coefficient than that of the insulation film 3. Furthermore, the protective film 4 is deposited on the protective film depositing surface part of the insulating film 3 by causing crystal growth of the insulating material. At that time, in a case where the protective film 4 has a large thickness, the protective film 4 peels off the insulating film 3. Accordingly, the protective film is formed so as to have a small thickness. More specifically, it is preferred that the film thickness of the protective film 4 is formed to be 100 nm or more and 300 nm or less. In this embodiment, the protective film 4 is formed of silicon oxide (SiO₂). As shown in Table 1, silicon oxide has a refractive index of 1.46 and a thermal expansion coefficient of 0.5×10⁻⁶/K. In this embodiment, since the insulating film 3 has a higher thermal expansion coefficient than that of the p-type cladding layer 10, the protective film 4 is required to have a lower thermal expansion coefficient than that of the insulating film 3, which is realized by using SiO₂. The material of the protective film 4 is not limited to SiO₂, and may be, for example, silicon nitride (SiN) and silicon (Si) as shown in Table 1 and may be a material having a lower thermal expansion coefficient than that of the insulating film 3.

The electrode 5 comprises an n-type ohmic electrode 12, a wire bonding electrode 17, a p-type ohmic electrode 15 and a die-bonding electrode 18. The n-type ohmic electrode 12 is formed in a substantially plate-like shape, and a cross section of the n-type ohmic electrode 12 seen as cut by a virtual plane perpendicular to the thickness direction of the n-type ohmic electrode 12 is formed in a substantially rectangular shape. The shape of the cross section of the n-type ohmic electrode 12 is formed in substantially the same as that of a cross section seen as cut by a virtual plane perpendicular to the thickness direction of the n-type substrate 6. The n-type ohmic electrode 12 is constituted so as to permit making an ohmic contact with the n-type substrate 6. The n-type ohmic electrode 12 is formed of an alloy. In this embodiment, the n-type ohmic electrode 12 is formed of an alloy in which germanium (Ge) is mixed into gold (Au) The wire bonding electrode 17 is formed in a plate-like shape, and is formed such that a cross section of the wire bonding electrode 17 seen as cut by a virtual plane perpendicular to the thickness direction has a substantially rectangular shape. The shape of the cross section of the wire bonding electrode 17 is formed so as to be substantially the same as the cross section seen as cut by a virtual plane perpendicular to the thickness direction of the n-type ohmic electrode 12. The wire bonding electrode 17 is constituted so that the wire bonding electrode 17 can be connected electrically to a wiring formed on a package substrate (not shown) with a fine metal wire, that is to say, so that the semiconductor laser element 1 can be wire-bonded to the package substrate. The wire bonding electrode 17 is constituted so as to be electrically connected to the n-type ohmic electrode 12. In this embodiment, the wire bonding electrode 17 is formed of Au.

The p-type ohmic electrode 15 is formed so as to be capable of covering one surface part in the thickness direction of the p-type capping layer 11. More specifically, the p-type ohmic electrode 15 is formed in a plate-like shape, and a cross section of the p-type ohmic layer 15 seen as cut by a virtual plane perpendicular to the thickness direction is formed in a rectangular shape extending longitudinally. Roughly, the cross section of the p-type ohmic electrode 15 is formed to be substantially the same as the cross section seen as cut by a virtual plane perpendicular to the thickness direction of the p-type capping layer 11, and is formed so as to have a large length in the width direction thereof as compared with the cross section of the p-type capping layer 11. The p-type ohmic electrode 15 is constituted to permit making an ohmic contact with the p-type capping layer 11. The p-type ohmic electrode 15 is formed of an alloy. In this embodiment, the p-type ohmic electrode 15 formed of an alloy which zinc (Zn) is mixed into gold (Au).

The die-bonding electrode 18 is formed so as to be capable of covering the protective film 4. The die-bonding electrode 18 is constituted to permit die-bonding to a package substrate when the semiconductor laser element 1 is to be die-bonded to the package substrate. When the die-bonding electrode 18 is die-bonded to the package substrate, the die-bonding electrode 18 is constituted to be connected electrically to a wiring formed on the package substrate. Further, the die-bonding electrode 18 is constituted so as to be capable of making electrical connection to the p-type ohmic electrode 15. In this embodiment, the die-bonding electrode 18 is formed of Au.

The semiconductor laser element 1 thus constituted is formed by depositing each layer as described hereinbelow. The n-type buffer layer 7 is deposited on the n-type substrate 6 so that one surface part in a deposition direction of the n-type substrate 6 and one surface part in the thickness direction of the n-type buffer layer 7 are opposed to each other. The deposition direction is the thickness direction of the n-type substrate 6, and is the direction in which each layer constituting the semiconductor laser element 1 is deposited. On the n-type buffer layer 7, the n-type cladding layer 8 is deposited so that another surface part in the thickness direction of the n-type buffer layer 7 and one surface part in the thickness direction of the n-type cladding layer 8 are opposed to each other. On the n-type cladding layer 8, the active layer 9 is deposited so that another surface part in the thickness direction of the n-type cladding layer 8 and one surface part in the thickness direction of the active layer 9 are opposed to each other. On the active layer 9, the p-type cladding layer 10 is deposited so that another surface part in the thickness direction of the active layer 9 and another surface part in the thickness direction of the p-type cladding layer 10 are opposed to each other. The other surface part in the thickness direction of the p-type cladding layer 10 is a surface part opposite to the thickness direction of one surface part of the p-type cladding layer 10. On the convex streak part 14, the p-type capping layer 11 is deposited so that the p-type capping layer 11 and one surface part on an opposed side in a height direction to a side where the convex streak part 14 faces the plate-like part 13, are opposed to each other. In this way, by depositing the p-type capping layer 11 on the convex streak part 14, a ridge part 19 shaped in a stripe and extending longitudinally is formed. Thus, on the n-type substrate 6, the compound semiconductor multilayer structure 2 is formed by depositing the n-type buffer layer 7, the n-type cladding layer 8, the active layer 9, the p-type cladding layer 10 and the p-type capping layer 11, sequentially in the deposition direction. The compound semiconductor multilayer structure 2 thus formed is configured in such a substantially rectangular parallelepiped that the ridge part 19 protruding on one side of the deposition direction is provided. The one side of the deposition direction is synonymous with a direction shown by an arrow X1 in which the n-type cladding layer 8 is deposited with respect to the n-type substrate 6.

On the compound semiconductor multilayer structure 2, the insulating film 3 is deposited so as to cover the non-formed surface part 16 of the p-type cladding layer 10 and both surface parts of the width direction of the ridge part 19. In other words, the insulating film 3 is deposited by covering one surface part on one side of the deposition direction of the compound semiconductor multilayer structure 2 (hereinafter, simply referred to as “one surface part of the compound semiconductor multilayer structure 2”, occasionally) so that an exposed surface part 20 of the ridge part 19 is exposed on one side of the deposition direction. The one surface part of the compound semiconductor multilayer structure 2 is a surface part on one side of the deposition direction out of both surface parts in the deposition direction and a surface part on the side where the p-type cladding layer 10 is formed. The exposed surface part 20 is synonymous with a surface part formed by the p-type capping layer 11 out of both surface parts in the height direction of the ridge part 19. On the insulating film 3, the protective film 4 is deposited so as to cover the protective film depositing surface part. That is to say, the protective film 4 is deposited on the insulating film 3 so that the exposed surface part 20 of the ridge part 19 is exposed on the one side of the deposition direction. On the exposed surface part 20 of the ridge part 19, the p-type ohmic electrode 15 is deposited so that the exposed surface part 20 and one surface part of the thickness direction of the p-type ohmic electrode 15 abut opposed to each other. On the p-type ohmic electrode 15 and the protective film 4, the die-bonding electrode 18 is deposited on the one side of the deposition direction so as to cover the p-type ohmic electrode 15 and the protective film 4. With the die-bonding electrode 18 being deposited in this way, the semiconductor laser element 1 is formed in a substantially rectangular parallelepiped.

On the compound semiconductor multilayer structure 2, n-type ohmic electrode 12 is deposited so that another surface part of the compound semiconductor multilayer structure 2 and one surface part of the thickness direction of the n-type ohmic electrode 12 are opposed to each other. That is to say, on the n-type substrate 6, the n-type ohmic electrode 12 is deposited so that another surface part in the deposition direction of the n-type substrate 6 and the n-type Ogmic electrode 12 are opposed to each other. Further, on the n-type ohmic electrode 12, the wire bonding electrode 17 is deposited so that another surface in the thickness direction of the n-type ohmic electrode 12 and one surface part of the wire bonding electrode 17 are opposed to each other. In this way, the semiconductor laser element 1 is formed by depositing the insulating film 3, the protective film 4, the p-type ohmic electrode 15, the die-bonding electrode 18, the n-type ohmic electrode 12 and the wire-bonding electrode 17, in the deposition direction. Next, a method of manufacturing the semiconductor laser element 1 thus formed will be explained.

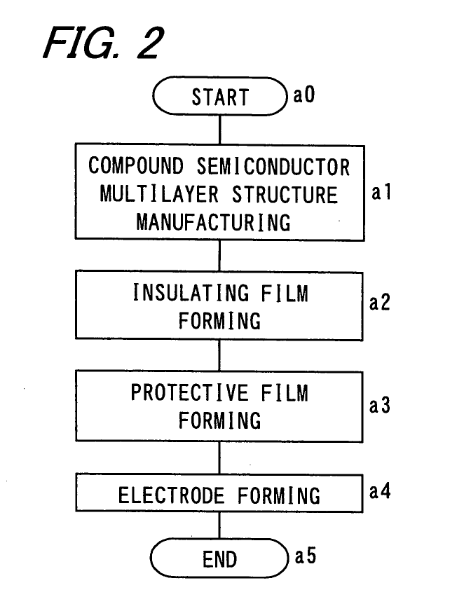

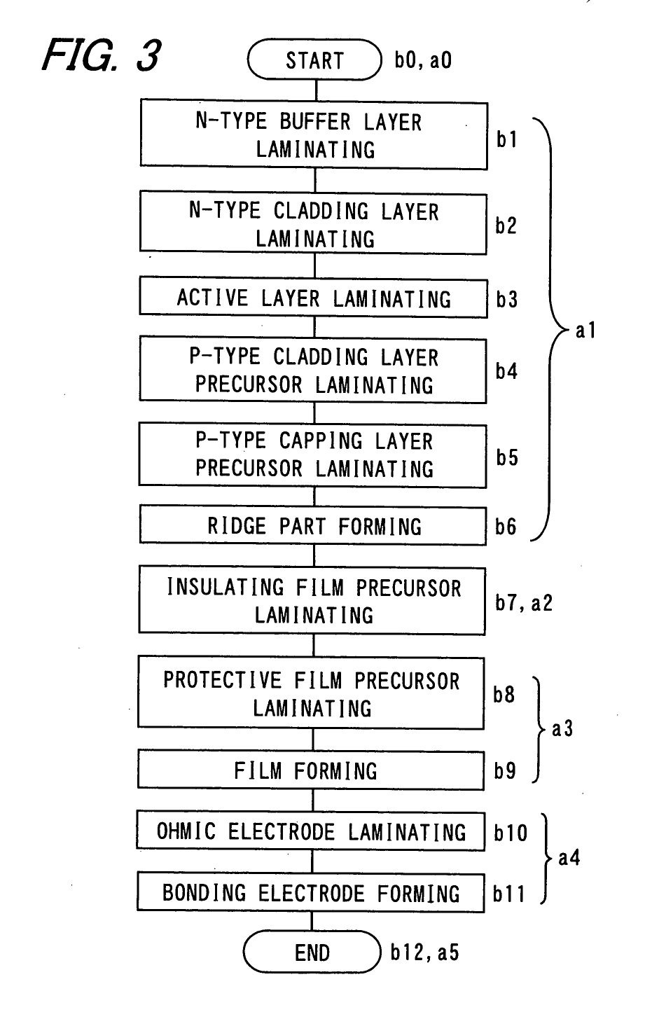

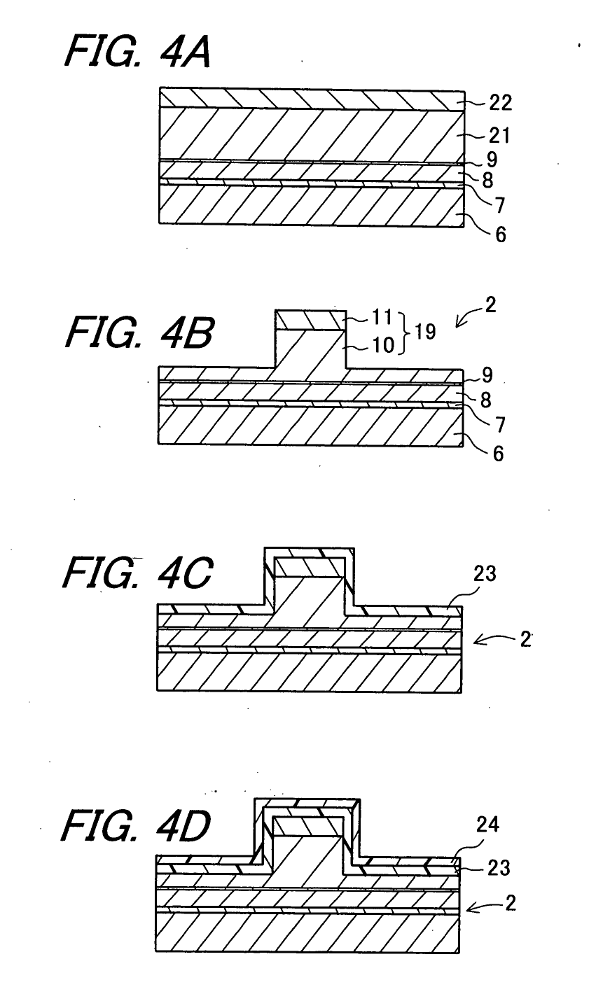

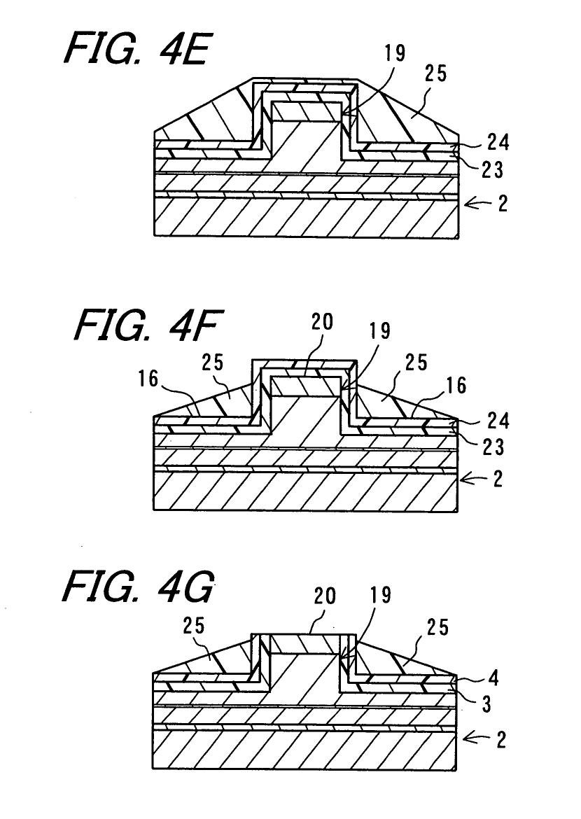

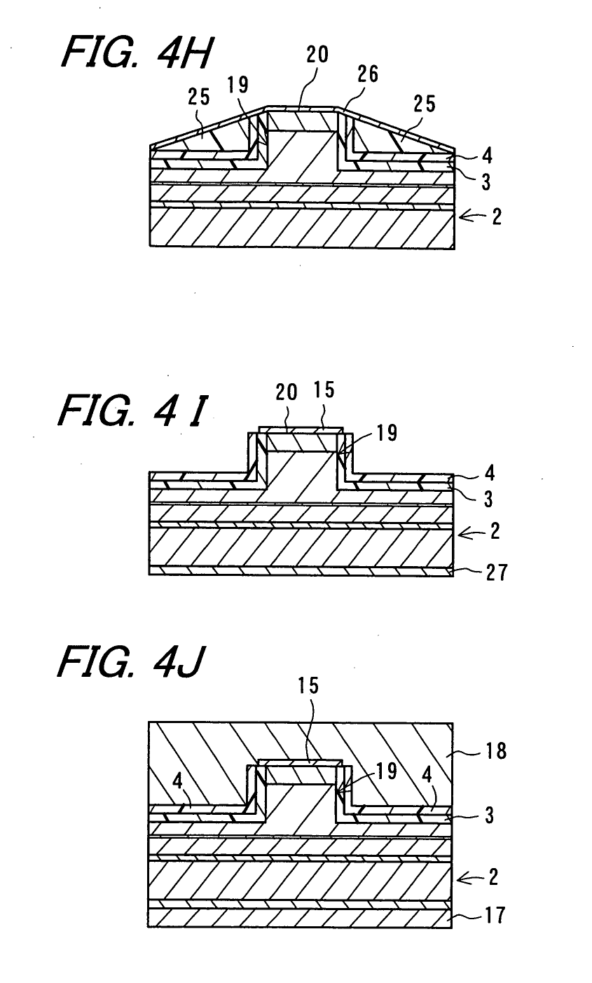

FIG. 2 is a flow chart showing simplistically the steps of manufacturing the semiconductor laser element 1. FIG. 3 is a flow chart showing the steps of manufacturing the semiconductor laser element 1. FIGS. 4A to 4J are views showing schematically the steps of manufacturing the semiconductor laser element 1. The steps of manufacturing the semiconductor laser element 1 include a compound semiconductor multilayer structure manufacturing step, an insulating film forming step, a protective film forming step and an electrode forming step. The step of manufacturing the semiconductor laser element 1 proceeds from step a0 to step a1, by putting the n-type substrate 6 in a reactor chamber of a metal organic chemical vapor deposition (abbreviated to MOCVD) crystal growth apparatus (not shown) to start crystal growth. In this embodiment, the MOCVD crystal growth apparatus is used, but the crystal growth apparatus is not limited to this particular apparatus. In this embodiment, the wording “above” is synonymous with “one side of the deposition direction and means above on the paper surface of FIGS. 1 and 4.

Step al serving as the compound semiconductor multilayer structure manufacturing step is a step of manufacturing the compound semiconductor multilayer structure 2 included in the semiconductor laser element 1, as shown in FIG. 4A. At the compound semiconductor multilayer structure manufacturing step, included are an n-type buffer layer depositing step, an n-type cladding layer step, an active layer step, a p-type cladding layer plate depositing step, a p-type capping layer plate depositing step and a ridge part forming step. When the routine proceeds to step a1, step b1 is started.

Step b1 serving as the n-type buffer layer depositing step is a step of depositing the n-type buffer layer 7 on one surface part of an n-type substrate 6. Specifically, at step b1, the n-type buffer layer 7 is deposited on the one surface of the n-type substrate 6 by doping a donor as well as by causing growth of a semiconductor crystal constituting the n-type buffer layer 7 on the one surface of the n-type substrate 6 by means of the MOCVD process. When then-type buffer layer 7 is deposited on the n-type substrate 6, the routine proceeds from step b1 to step b2.

Step b2 serving as the n-type cladding layer depositing step is a step of depositing the n-type cladding layer 8 on the n-type buffer layer 7. Specifically, at step b2, the n-type cladding layer 8 is deposited on the other surface of the n-type buffer layer 7 by doping a donor as well as by causing growth of a semiconductor crystal constituting the n-type cladding layer 8 on the n-type buffer layer 7 by means of the MOCVD process. At step b2 of this embodiment, in order to cause crystal growth of n-Al_{0.5}Ga_{0.5}As, trimethylaluminum ((CH₃)₃Al: abbreviated to TMA), trimethyl gallium ((CH₃)₃Ga: abbreviated to TMG) and arsenic hydride (AsH₃: arsine gas) are used as materials of the semiconductor crystal, and disilicon hexahydride (Si₂H₆: disilane gas) is used as an n-type impurity dopant material. When the n-type cladding layer 8 is deposited on the n-type buffer layer 7, the routine proceeds from step b2 to step b3.

Step b3 serving as the active layer depositing step is a step of depositing an active layer 9 on the other surface part of the n-type cladding layer 8 which is deposited at step b2. Specifically, at step b3, the active layer 9 is deposited on the other surface of the n-type cladding layer 8 by causing growth of a semiconductor crystal constituting the active layer 9 on the other surface part of the n-type cladding layer 8 by means of the MOCVD process. At step b3 of this embodiment, in order to cause crystal growth of n-Al_{0.13}Ga_{0.87}As, trimethylaluminum ((CH₃)₃Al: abbreviated to TMA), trimethyl gallium ((CH₃)₃Ga: abbreviated to TMG) and arsenic hydride (AsH₃: arsine gas) are used as materials of the semiconductor crystal. When the active layer 9 is deposited on the other surface part of the n-type cladding layer 8, the routine proceeds from step b3 to step b4.

Step b4 serving as a p-type cladding precursor depositing step is a step of depositing a p-type cladding precursor 21 on the other surface part of the active layer 9 which is deposited at step b3. The p-type cladding layer precursor 21 is a precursor of the p-type cladding layer 10 formed in a plate-like shape, and the p-type cladding layer 10 is formed when the precursor is etched. Accordingly, the p-type cladding layer precursor 21 is formed so that the thickness thereof is substantially the same as the sum of a thickness of the plate-like part 13 of the p-type cladding layer 10 and a height of the convex streak part 14. Further, in the p-type cladding layer precursor 21, a cross section seen as cut by a virtual plane perpendicular to the thickness direction thereof is substantially the same as a cross section seen as cut by a virtual plane perpendicular to the thickness direction of the p-type cladding layer 10. More specifically, at step b4, growth of a semiconductor crystal constituting the p-type cladding layer 10 is caused on the other surface of the active layer 9 by means of the MOCVD process, and an acceptor is doped as well. In this way, the p-type cladding layer precursor 21 is deposited on the other surface part of the active layer 9. In step b4 of this embodiment, in order to cause crystal growth of n-Al_{0.5}Ga_{0.5}As, trimethylaluminum ((CH₃)₃Al: abbreviated to TMA), trimethyl gallium ((CH₃)₃Ga: abbreviated to TMG) and arsenic hydride (AsH₃: arsine gas) are used as materials of the semiconductor crystal, and diethylzinc ((C₂H₅)₂Zn: abbreviated to DEZ) is used as a p-type impurity dopant material. When the p-type cladding layer precursor 21 is deposited on the other surface part of the active layer 9, the routine proceeds from step b4 to step b5.

Step b5 serving as a p-type capping layer plate depositing step is a step of depositing a p-type capping layer precursor 22 on the p-type cladding layer precursor 21. The p-type capping layer precursor 22 is a precursor of the p-type capping layer 11 formed in a plate-like shape, and the p-type capping layer 11 is formed when the precursor is etched. Accordingly, the p-type cladding layer precursor 22 is formed so that the thickness thereof is substantially the same as the thickness of the p-type capping layer 11. Further, in the p-type cladding layer precursor 22, a cross section seen as cut by a virtual plane perpendicular to the thickness direction thereof is substantially the same as a cross section seen as cut by a virtual plane perpendicular to the thickness direction of the p-type cladding layer precursor 21. More specifically, at step b5, growth of a semiconductor crystal constituting the p-type capping layer 11 is caused on the p-type cladding layer 10 by means of the MOCVD process, and an acceptor is doped as well. In this way, the p-type capping layer precursor 22 is deposited on the p-type cladding layer precursor 21. At step b5 of this embodiment, in order to cause crystal growth of n-GaAs, trimethyl gallium ((CH₃)₃Ga: abbreviated to TMG) and arsenic hydride (AsH₃: arsine gas) are used as materials of the semiconductor crystal, and diethylzinc ((C₂H₅)₂Zn: abbreviated to. DEZ) is used as an p-type dopant material. When the p-type capping layer precursor 22 is deposited on the p-type cladding layer precursor 21, the routine proceeds from step b5 to step b6.

As shown in FIG. 4B, step b6 serving as the ridge part forming step is a step of forming the p-type cladding layer 10 and the p-type capping layer 11 by etching the p-type cladding layer precursor 21 and the p-type capping layer precursor 22. Specifically, etching is carried out so that the p-type capping layer 11 and the convex streak part 14 of the p-type cladding layer 10 are formed which are to be formed on a surface part facing one side of the deposition direction toward another side of the deposition direction of the p-type capping layer precursor 22. Thus, the p-type cladding layer 10 and the p-type capping layer 11 are formed on the active layer 9. That is to say, the ridge part 19 is formed on the active layer 9. By forming the ridge part 9 in this way, the compound semiconductor multilayer structure 2 is formed. When the compound semiconductor multilayer structure 2 is formed, step b6 is finished. That is to say, step a1 serving as the compound semiconductor multilayer structure manufacturing step is finished, and the routine proceeds from step a1 to step a2.

As shown in FIG. 4C, step a2 serving as the insulating film forming step is a step of depositing the insulating film precursor 23 on one surface part of the compound semiconductor multilayer structure 2. The insulating film forming step may be referred to as an insulating film precursor depositing step. As shown in FIG. 3, step a2 is synonymous with step b7. The insulating film precursor 23 is a precursor of the insulating film 3 which is formed by removing, by means of a lithography process, a part of the insulating film precursor 23 covering the entire surface of the one surface of the compound semiconductor multilayer structure 2. Specifically, at step a2, the insulating film precursor 23 is deposited on the one surface part of the compound semiconductor multilayer structure 2 by causing growth of a crystal constituting the insulating film precursor 23, namely a crystal constituting the insulating film 3 on the one surface part of the compound semiconductor structure 2 by means of a plasma CVD process. At that time, in order to prevent the insulating film precursor 23 from peeling off the one surface part of the compound semiconductor multilayer structure 2, namely, from peeling off the p-type cladding layer 10 and the p-type capping layer 11, the insulating film precursor 23 is formed to have a thickness of 100 nm or more and 300 nm or less. Note, however, that the thickness of the insulating film precursor 23 is not limited to this particular range and may be in such a range that it is possible to prevent the insulating film precursor 23 from peeling off the p-type cladding layer 10 and the p-type capping layer 11. In this embodiment, the insulating film is deposited on the one surface part of the compound semiconductor multilayer structure 2 by causing crystal growth of Al₂O₃ on the p-type cladding layer 10 and the p-type capping layer 11 by means of a CVD process. In this way, the insulating film precursor 23 is deposited on the one surface part of the compound semiconductor multilayer structure 2, and thereby, the routine proceeds from step a2 to step a3.

Step a3 serving as the protective film forming step comprises a protective film precursor depositing step and a film forming step. The protective film forming step is a step of forming the insulating film 3 and the protective film 4 on the one surface part of the compound semiconductor multilayer structure 2. When the routine proceeds to step a3, step b8 is started. As shown in FIG. 4D, step b8 serving as the protective layer depositing step is a step of depositing a protective film precursor 24 on the insulating film precursor 23. The protective film precursor 24 is a precursor of the protective film 4 which is formed by removing, by means of the lithography process, a part of the insulating film precursor 23 covering the entire surface of the insulating film precursor 23. Specifically, the protective film precursor 24 is deposited on the insulating film precursor 23 by causing growth of a crystal constituting the protective film precursor 24, namely a crystal constituting the protective film 4 by means of the plasma CVD process. At that time, in order to prevent the protective film precursor 24 from peeling off the insulating film precursor 23, namely in order to prevent the protective film 4 from peeling off the insulating film 3, the protective film precursor 24 is formed to have a thickness of 100 nm or more and 300 nm or less. Note, however, that the thickness of the protective film precursor 24 is not limited to this particular range and may be in such a range that it is possible to prevent the protective film precursor 24 from peeling off the insulating film precursor 23. In this embodiment, by causing crystal growth of SiO₂ on the insulating film precursor 23 by means of a CVD process, the protective film precursor is deposited on the insulating film precursor 23. In this way, the protective film precursor 24 is deposited on the insulating film precursor 23, and thereby, the routine proceeds from step b8 to step b9.

As shown in FIGS. 4E to 4G, step b9 serving as the film forming step is a step of forming the insulating film 3 and the protective film 4 by removing by means of the lithography process a part of the insulating film precursor 23 deposited at step a2, namely at step b7 and the protective film precursor 24 deposited at step b8. More specifically, at step b9, as shown in FIG. 4E, a photoresist film 25 is formed on the protective film precursor 24 by applying a photoresist thereon by using a spin-coating method. Next, as shown in FIG. 4F, the photoresist film 25 is exposed to light for photography such as an ultraviolet ray in a state where the photoresist film 25 is covered with a photomask and the exposed resist film 25 is developed so that the photoresist film 25 on the non-formed surface part 16 is left and the photoresist film 25 of a portion formed above an exposed surface part of the ridge part 19 is removed. Further, as shown in FIG. 4G, the portion from which the photoresist film 25 has been removed is etched downwardly, to remove the portion of the protective film precursor 23 and the insulating film precursor 24 which are formed above the exposed surface 20 of the ridge part 19. In this way, the insulating film 3 and the protective film 4 can be formed on the compound semiconductor multilayer structure 2. When the insulating film 3 and the protective film 4 are formed, step b9 is finished. That is to say, step a3 serving as the protective film forming step is finished, and the routine proceeds to step a4.

Step a4 serving as the electrode forming step is a step of depositing the electrode 5 on the compound semiconductor multilayer structure 2. The electrode forming step comprises an ohmic electrode depositing step and a bonding electrode forming step. When the routine proceeds to step a4, step b10 is started. Step b10 serving as the ohmic electrode depositing step is a step of depositing the p-type ohmic electrode 15 and the n-type ohmic electrode 12 on the compound semiconductor multilayer structure 2. Specifically, at step b10, a metal constituting the p-type ohmic electrode 15 is vacuum-deposited on the compound semiconductor multilayer structure 2 from the one side of the deposition direction of the compound semiconductor multilayer structure 2. In other words, a metal constituting the p-type ohmic electrode 15 is vacuum-deposited on the ridge part 19 and the photoresist film 25 in such a manner that the exposed surface part 20 of the ridge part 19 and the photoresist film 25 are covered, to form a p-type ohmic electrode precursor 26. The p-type ohmic electrode precursor 26 is a precursor of the p-type ohmic electrode 15. After the p-type ohmic electrode precursor 26 is formed, the p-type ohmic electrode precursor 26 formed above the non-formed surface part 16 can be removed by eliminating the photoresist film 25. That is to say, the p-type ohmic electrode 15 is formed on the exposed surface part 20 of the ridge part 19. In this way, the p-type ohmic electrode 15 can be deposited on the ridge part 19. Furthermore, the n-type ohmic electrode 12 is formed by vacuum-depositing a metal constituting then-type ohmic electrode 12 on the compound semiconductor multilayer structure 2 from the other side of the deposition direction of the compound semiconductor multilayer structure 2. As a result, the n-type ohmic electrode 12 can be deposited on the other surface part of the n-type substrate 6. In this way, the p-type ohmic electrode 15 can be deposited on the ridge part 19 of the compound semiconductor multilayer structure 2, and the n-type ohmic electrode 12 can be deposited on the n-type substrate 6 of the compound semiconductor multilayer structure 2. In this embodiment, the p-type ohmic electrode 15 is formed by vacuum-depositing Au and Zn on the photoresist film 25 and the ridge part 19. The n-type ohmic electrode 12 is formed by vacuum-depositing Au and Ga on the n-type substrate 6. When the p-type ohmic electrode 15 and the n-type ohmic electrode 12 are deposited on the compound semiconductor multilayer structure 2, the routine proceeds from step b10 to step b11.

Step b11 serving as the bonding electrode forming is a step of depositing the die-bonding electrode 18 on the p-type ohmic electrode 15 and the protective film 4 and depositing a wire bonding electrode 17 on the other surface part of the n-type ohmic electrode 12. Specifically, at step b11, the die-bonding electrode 18 is formed by vacuum-depositing a metal constituting the die-bonding electrode 18 on the p-type ohmic electrode 15 and the protective film 4 so as to cover the p-type ohmic electrode 15 and the other surface part of the protective film 4. The other surface of the protective film 4 is a surface part opposite to the thickness direction of a surface part to which the protective film 4 and the insulating film 3 are opposed. Further, on the other surface part of the n-type ohmic electrode 12, a wire bonding electrode 17 is formed by vacuum-depositing a metal constituting the wire bonding electrode 17 so as to cover the other surface part. In this embodiment, by vacuum-depositing Au, the die-bonding electrode 18 is deposited on the protective film 4 and the p-type ohmic electrode 15, and the die-bonding electrode 17 is deposited on the n-type ohmic electrode 12. When the die-bonding electrode 18 and the wire bonding electrode 17 are thus deposited, step b11 is finished. That is to say, step a4 serving as the electrode forming step is finished. When step a4 is finished, the routine proceeds to step a5, and the step of manufacturing method of the semiconductor laser element 1 is finished. By means of this manufacturing method, the semiconductor laser element 1 can be manufactured.

In the semiconductor laser element 1 thus manufactured, the one surface part of the compound semiconductor multilayer structure 2 is insulated by being covered with an insulating film 27, excluding the part deposited by the p-type ohmic electrode 15. The insulating layer 27 is synonymous with a layer including the protective film 4 and the insulating film 3. Since the portion covered with the insulating layer 27 is insulated, an electric current is prevented from flowing therethrough. With this configuration, it is possible to concentrate holes injected from the die-bonding electrode 18 into the p-type ohmic electrode 15 on which the insulating layer 27 is not formed. That is to say, an electro-current constriction is made possible. Since the p-type ohmic electrode 15 is formed of an alloy of Au containing an impurity Zn, this electrode permits making an ohmic contact with the p-type capping layer 11 which is a semiconductor. As a result, an electric current can be flowed from the p-type ohmic electrode 15 to the p-type capping layer 11. Accordingly, the holes of the die-bonding electrode 18 can be injected into the ridge part 19 via the p-type ohmic electrode 15. This enables the holes to be concentrated into the proximity of the convex streak part 14 and further, the holes concentrated are injected into the active layer 9. Furthermore, the n-type ohmic electrode 12 formed of an alloy of Au containing Ge is deposited on the wire bonding electrode 17. This permits making an ohmic contact between the n-type ohmic electrode 12 and the n-type substrate 6. Thereby, electrons of the wire bonding electrode 17 can be injected into the n-type substrate 6 via the n-type ohmic electrode 12. Electrons to be injected into the n-type substrate 6 are injected to the active layer 9 via the n-type buffer layer 7 and the n-type cladding layer 8.

In this way, holes can be injected from the p-type cladding layer 10 into the active layer 9, and electrons can be injected from the n-type cladding layer 8 into the active layer 9. When these holes and electrons injected into the active layer 9 are recombined radiatively, a layer beam is produced inside the semiconductor laser element 1. When an electric current is flowed between the die-bonding electrode 18 and the wire bonding electrode 17 by positively charging the die-bonding electrode 18 and by negatively charging the wire bonding electrode 17, a laser beam is produced through radiative recombination inside the semiconductor laser element 1. The laser beam is guided to be amplified inside the semiconductor laser element 1 and then is emitted from a cleavage plane of one side of the longitudinal direction of the semiconductor laser element 1. In this way, the semiconductor laser element 1 is constituted so that a laser beam can be emitted. Advantageous effects that the semiconductor laser element 1 can accomplish will be described hereinbelow.

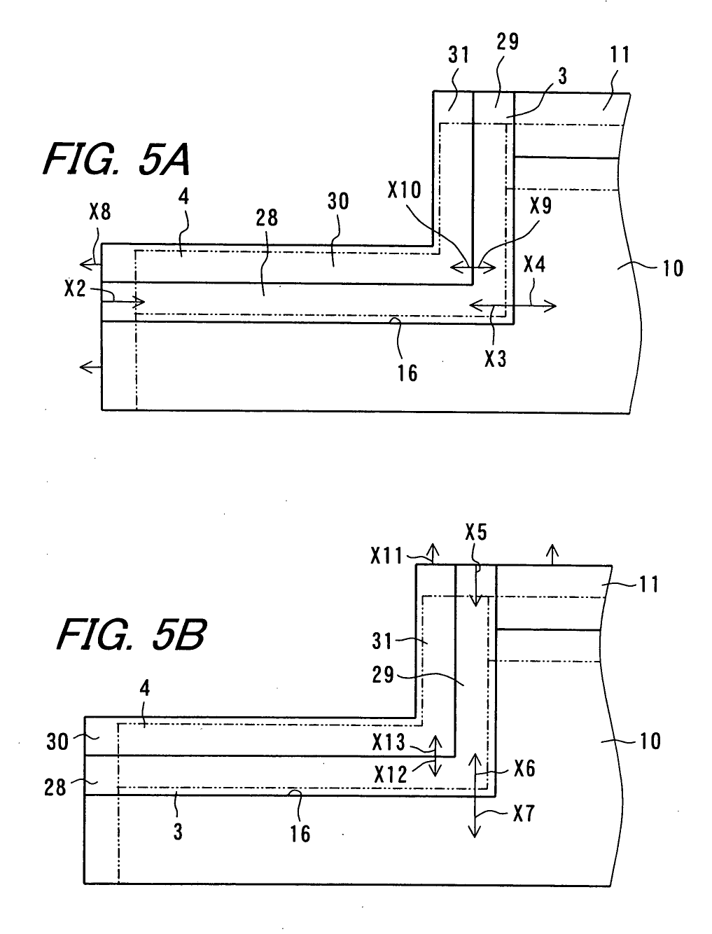

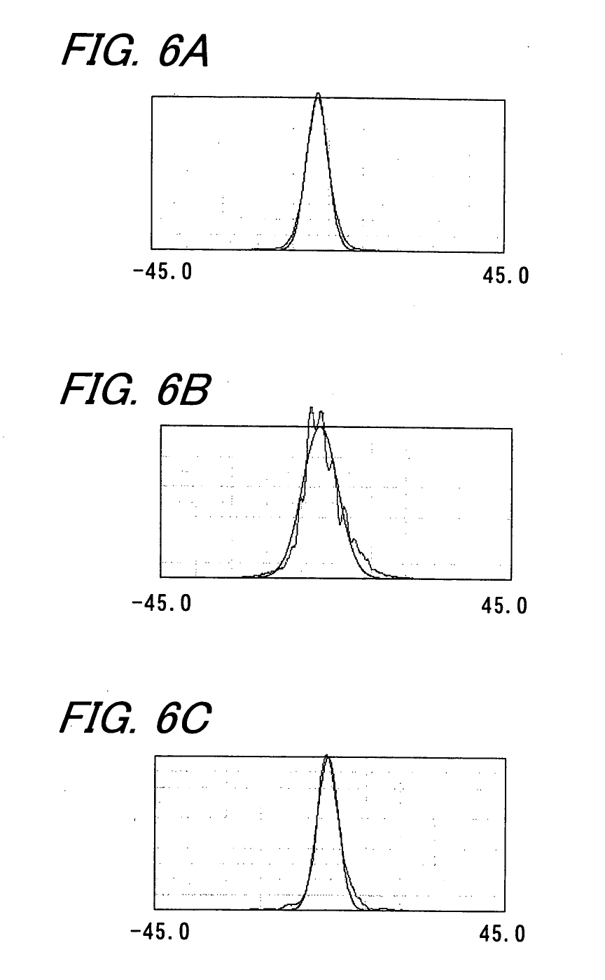

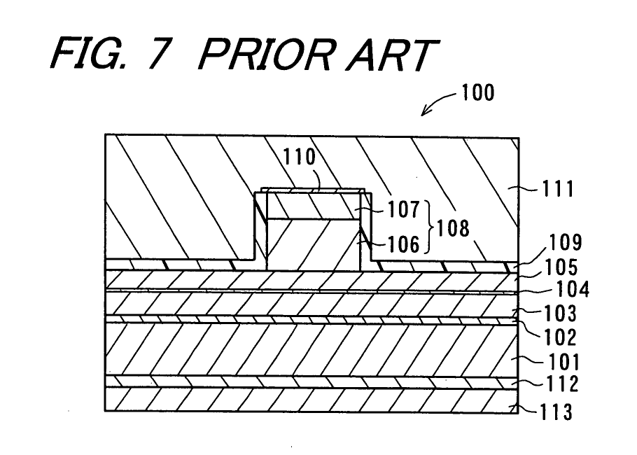

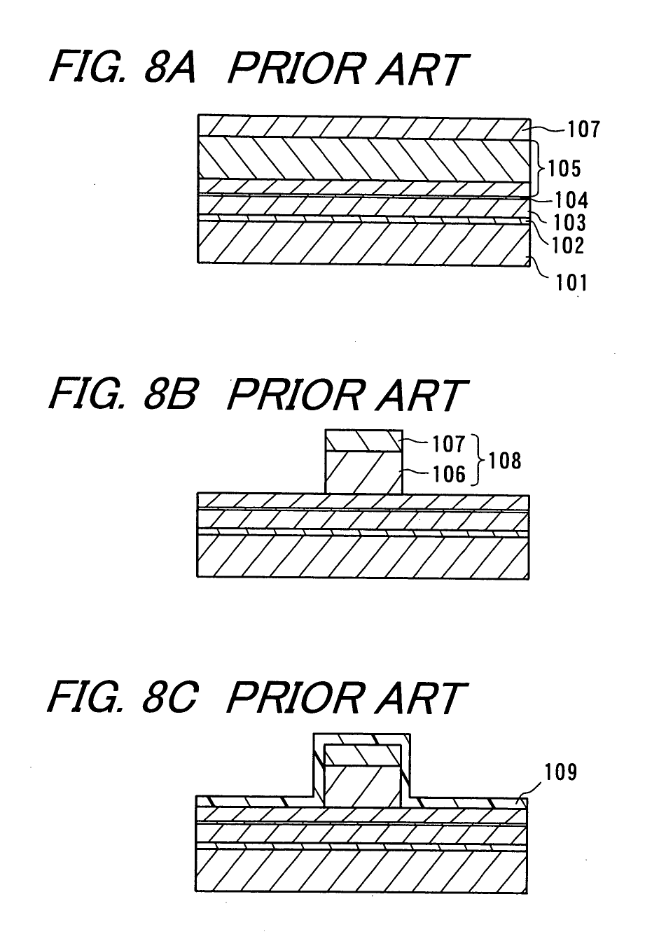

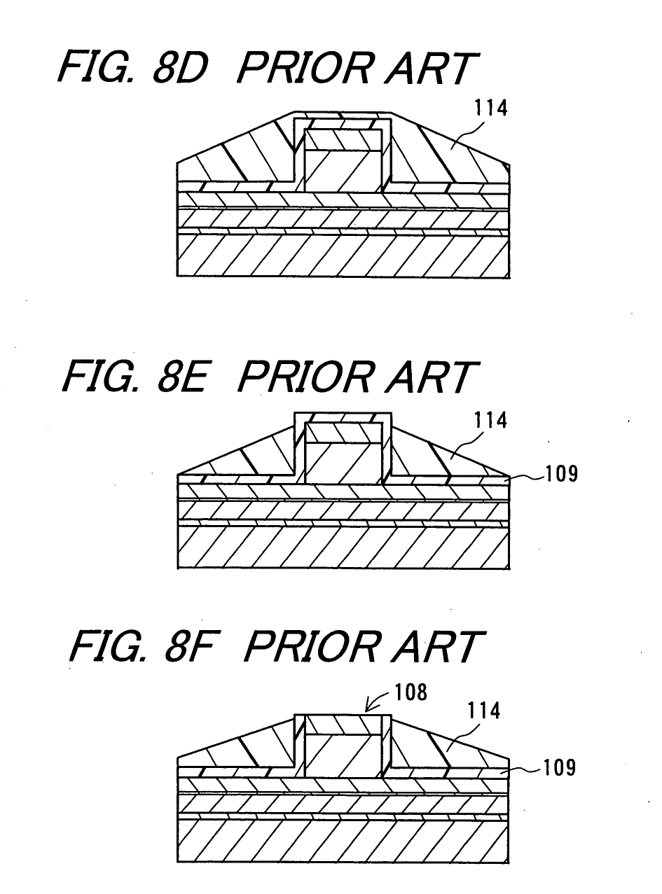

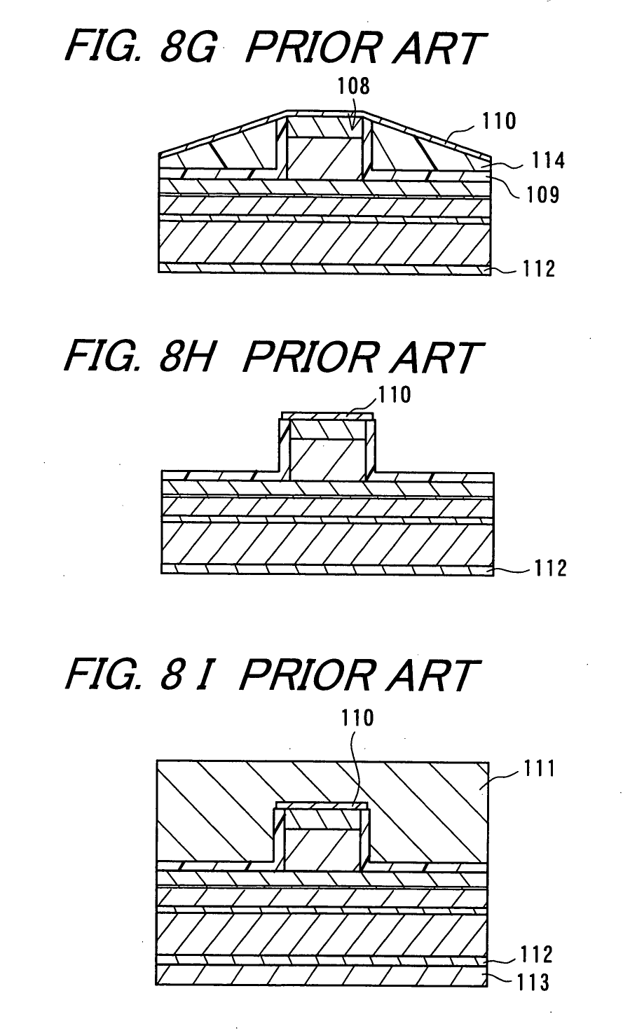

FIGS. 5A and 5B are views showing schematically the stress relationship between the insulating film 3, the protective film 4 and the p-type cladding layer 10, by enlarging a part of the semiconductor laser element 1. FIG. 5A is a view showing schematically the stress relationship in the width direction of the insulating film 3, the protective film 4 and the p-type cladding layer 10, by enlarging a part of the semiconductor laser element 1. FIG. 5B is a view showing schematically the stress relationship in the deposition direction of the insulating film 3, the protective film 4 and the p-type cladding layer 10, by enlarging a part of the semiconductor laser element 1. FIGS. 6A to 6C are graphs showing far field patterns (abbreviated to FFPs) of laser beams emitted. FIG. 6A is a graph showing an FFP in a case where GaAlAs is deposited on the p-type cladding layer 10. FIG. 6B is a graph showing an FFP in a case where SiN is deposited on the p-type cladding layer 10. FIG. 6C is a graph showing an FFP in a case where the insulating layer 27 is deposited on the p-type cladding layer 10. In FIGS. 6A, 6B and 6C, the vertical axis of FFP shows a percentage relative to a maximum value of a laser beam output, and the horizontal axis shows a half-value angle. Hereto, on the assumption that there is a great difference in thermal expansion coefficient between the insulating film 3 and the p-type cladding layer 10, explanation will be given regarding a case where thermal stress acts on this semiconductor laser element 1. In the active layer 9, holes and electrons are recombined radiatively to emit a laser beam, and at the same time, holes and electrons are recombined in a non-radiative manner to produce heat. As shown in FIGS. 5A and 5B, in the semiconductor laser element 1, the p-type cladding layer 10 and the insulating film 3 cause thermal expansion due to this heat. Since the p-type cladding layer 10 and the insulating film 3 are formed integrally by means of a crystal growth process, they prevent thermal expansion by restraining each other, and thereby, thermal stress acts on the p-type cladding layer 10.

More specifically, the insulating film 3 is formed so that one surface part of the thickness direction of an insulating film base 28 is opposed to the non-formed surface part 16, and one end part of the width direction of the insulating film base 28 is formed integrally with the ridge part 19. The insulating film 3 is formed so that one surface part of the thickness direction of an insulating film protruding part 29 is formed integrally with the ridge part 19 and that one end part of the width direction the insulating film protruding part 29 is formed on the non-formed surface part 16. The insulating film base 28 is a part formed in a plate-like shape extending in the width direction, out of the insulating film 3, and the insulating film protruding part 29 is a part protruding to the deposition direction from the one end part of the width direction of the insulating film base 28. Hereto, for convenience of explanation, the insulating film protruding part 29 is assumed to comprise the one end part of the width direction of the insulating film base 28. Since the insulating film base 28 is thus formed integrally, in a case where the insulating film 3 has a higher thermal expansion coefficient than that of the plate-like part 13, when heat is applied to the insulating film 3 and the p-type cladding layer 10, compressive forces shown by arrows X2 and X3, respectively, as shown in FIG. 5A, act on the insulating film base 28 from the p-type cladding layer 10 toward the insulating film 3 so as to restrict thermal expansion of the insulating film base 28. Since the compressive forces act on the insulating film base 28, a compressive force shown by the arrow X4 acts on the convex streak part 14 as a reactive force against the compressive force shown by the arrow X3 on the principle of action and reaction. In the p-type cladding layer 10, compressive stress according to this compressive force is caused. Further, at the same time, when heat is applied to the insulating film 3 and the p-type cladding layer 10, compressive forces shown by the arrows X5 and X6 as shown in FIG. 5B act on the insulating film protruding part 29 from the p-type cladding layer 10 toward the insulating film 3 so as to prevent thermal expansion of the insulating film protruding part 29. Since the compressive forces act on the insulating film protruding part 29, a compressive force shown by the arrow X7 acts on the plate-like part 13 as a reactive force against these compression forces on the principle of action and reaction. Compressive stress according to this compressive force is caused in the p-type cladding layer 10. In a case where the insulating film 3 and the p-type cladding layer 10 are formed integrally, and where the insulating film 3 has a greater thermal expansion coefficient than that of the p-type cladding layer 10, the insulating film 3 causes compressive stress in the cladding layer 10. That is to say, compressive stress acts on the p-type cladding layer 10.

Thus, when compressive thermal stress acts on the p-type cladding layer 10, strain and crystal defects occur in the active layer 9. Due to these strain and crystal defects in the active layer 9, holes and electrons are recombined in a non-radiative manner to generate heat. This heat generated increases compressive thermal stress and causes an increase of crystal defects. A semiconductor laser element 1 in which there is a great difference in thermal expansion coefficient between the insulating film 3 and the p-type cladding layer 10 gets caught in a vicious cycle of heat generation and crystal defects, resulting in giving rise to bulk deterioration. Thereby, a laser beam emitted by a semiconductor laser element causes a dark region (abbreviated to DR) and a dark line defect (abbreviated to DLD) which are attributable to bulk deterioration.

According to the semiconductor laser element 1 of the embodiment of the invention, the thermal expansion coefficient of the p-type cladding layer 10 is approximate to that of the insulating film 3. Accordingly, the amount of thermal expansion of the p-type cladding layer 10 is approximate to that of the insulating film 3, and it is possible to prevent compressive thermal stress which acts on the p-type cladding layer 10. By preventing compressive thermal stress which acts on the p-type cladding layer 10, it is made possible to prevent crystal defects from occurring in the active layer 9 and therefore, to also prevent bulk deterioration from occurring. Through this prevention of bulk deterioration, it is possible to prevent DR and DLD from occurring, and this enables the semiconductor laser element 1 to have a longer emission life than the conventional laser element 100. In other words, it is possible to manufacture the semiconductor laser element 1 with higher reliability.

Further, in the semiconductor laser element 1 according to this embodiment, the protective film 4 is deposited integrally with the insulating film 3. The protective film 4 is formed of a material having a lower thermal expansion coefficient than that of the insulating film 3. The protective film 4 thus causes tensile stress to act on the insulating film 3. In this way, when the tensile stress acts on the insulating film 3, it is possible to relax a compression force which the insulating film 3 applies to the p-type cladding layer 10. That is to say, the protective film 4 relaxes compressive thermal stress of the p-type cladding layer 10 by apparently causing a tensile force to act on the p-type cladding layer 10. In this way, by depositing the protective film 4 on the insulating film 3, it is possible to relax compressive thermal stress in the p-type cladding layer 10.

More specifically, the protective film 4 is formed so that one surface part of the thickness direction of a protective film base 30 is formed on another surface of the thickness direction of the insulating film base 28, and one end part of the width direction the protective film base 30 is formed integrally with an insulating film protruding part 29. In the protective film 4, one surface part of the thickness direction of the protective film protruding part 31 is formed integrally with the insulating film protruding part 29, and one end part of the width direction of the protective film protruding part 31 is formed on the protective film base 30. The protective film base 30 is a part formed in a plate-like shape extending in the width direction, out of the protective film 4, and the protective film protruding part 31 is a part protruding to the deposition direction from one end part of the width direction of the protective film base 30. Here, for convenience of explanation, the protective film protruding part 31 comprises the one end part of the width direction of the protective film base 30. With this integral configuration, in a case where the protective film 4 has a lower thermal expansion coefficient than that of the insulating film 3, when heat is applied to the protective film 4 and the insulating film 3, tensile forces shown by arrows X8 and X9, as shown in FIG. 5A, act on the protective film base 30 from the insulating film 3 toward the protective film 4 so as to promote expansion of the protective film base 30. Since the tensile forces act on the protective film base 30, a tensile force shown by the arrow X10 acts on the insulating film protruding part 29 as a reactive force against these tensile forces on the principle of action and reaction. Further, at the same time, when heat is applied to the protective film 4 and the insulating film 3, tensile forces shown by the arrows X11 and X12, as shown in FIG. 5B, act on the protective film protruding part 31 from the insulating film 3 toward the protective film 4 so as to promote expansion of the protective film protruding part 31. Since a tensile force acts on the protective film protruding part 31, a compressive force shown by the arrow X13 acts on the insulating film base 30 as a reactive force against this tensile force on the principle of action and reaction. In this way, in a case where the protective film 4 is deposited integrally with the insulating film 3, when heat is applied to the protective film 4 and the insulating film 3, the protective film 4 applies a tensile force to the insulating film 3. Accordingly, a compressive force applied to the p-type cladding layer 10 by the insulating film 3 is relaxed. That is to say, the protective film 4 relaxes compressive thermal stress of the p-type cladding layer 10 by apparently causing a tensile force to act on the p-type cladding layer 10. In this way, by depositing the protective film 4 on the insulating film 3, it is made possible to relax compressive thermal stress of the p-type cladding layer 10. In this way, since compressive thermal stress that occurs in the p-type cladding layer 10 can be relaxed, it is possible to prevent strain and crystal defects in the active layer 9 and to prevent bulk deterioration from occurring. Therefore, there is no occurrence of DR and DLD, and this enables the semiconductor laser element 1 to have a longer emission lifetime than the conventional semiconductor laser element 100. In other words, it is possible to manufacture the semiconductor laser element 1 with higher reliability than the conventional semiconductor laser element 100. Although in this embodiment, the protective film 4 is formed of SiO₂, it is possible to relax thermal stress of the p-type cladding layer 10 in the same way as mentioned above, by forming the protective film 4 by SiN and Si having a lower thermal expansion coefficient than that of alumina.

In this embodiment, the insulating film 3 is more away from the active layer 9, which is a heat generating source, than the p-type cladding layer 10, and as compared with the p-type cladding layer 10, the heat transfer amount in the insulating film 3 from the active layer 9 is small and the temperature change is also small. Accordingly, the p-type cladding layer 10 becomes easier to expand thermally, and the insulating film 3 becomes harder to expand thermally. Therefore, with the insulating film 3 being formed of Al₂O₃ having a higher thermal expansion coefficient than that of the p-type cladding layer 10, it is possible to reduce the difference in thermal expansion amount of the insulating film 3 from the p-type cladding layer 10 and to reduce compressive thermal stress that occurs in the p-type cladding layer 10. Thereby, it is possible to further reduce thermal stress that occurs in the p-type cladding layer 10.

The active layer 9 is formed to have a higher refractive index than the p-type cladding layer 10 and the n-type cladding layer 8. With this constitution, a laser beam guided can be confined to the proximity of the active layer 9. In other words, it is possible to confine the laser beam to a vertical direction of the active layer 9. The vertical direction is synonymous with the deposition direction. The refractive index of the insulating film 3 is lower than that of the p-type cladding layer 10. Accordingly, real refractive index of an intermediate part in the width direction of the compound semiconductor multilayer structure 2 becomes higher than that of both end parts in the width direction of the compound semiconductor multilayer structure 2. Hereto, the intermediate part in the width direction of the compound semiconductor multilayer structure 2 is a part in which a ridge part is formed in the width direction of the compound semiconductor multilayer structure 2, and the both end parts in the width direction of the compound semiconductor multilayer structure 2 is a part excluding the intermediate part of the width direction in the width direction of the compound semiconductor multilayer structure 2. Thus, the laser beam guided is confined to the proximity of the intermediate part of the width direction. That is to say, it becomes possible to confine the laser beam guided to a lateral direction. Hereto, “the proximity of the intermediate part of the width direction” includes the intermediate part of the width direction, and the lateral direction is synonymous with the width direction of the semiconductor laser element 1. In the semiconductor laser element 1 of this embodiment, since the protective film 4 is formed on the insulating film 3, it is possible to increase the difference of real refractive index between the intermediate part of the width direction and the both end parts, as compared with the conventional semiconductor laser element 100. In this way, it is possible to further enhance the lateral confinement. Since the lateral confinement can be thus enhanced, it is possible to increase the output of a laser beam to be emitted.

In the semiconductor laser element 1, the insulating film 3 and the protective film 4 whose lattice constants are different from each other are deposited on the p-type cladding layer 10. By thus depositing an insulating film and a protective film whose lattice constants are different from each other, the insulating film 3 and the protective film 4 serve as a buffer layer, respectively. This enables lattice constant matching between the p-type cladding layer 10 and the insulating film 3, and between the insulating film 3 and the protective film 4. It is possible to prevent the lattice relaxation of the insulating film 3 and the protective film 4, namely to prevent the peeling of the insulating film 3 and the protective film 4. Accordingly, even in a case where it is impossible to deposit to a thickness with one of the insulating film 3 and the protective film 4, the thickness can be realized by the insulating layer 27, by depositing the insulating layer 27 on the p-type cladding layer 10. To be more specific, the insulating film 3 formed of Al₂O₃ and the protective film 4 formed of SiO₂ cause peeling when the film thickness is about 300 nm. Depositing the insulating film 3 and the protective film 4 enables the insulating layer 27 to have a thickness of 300 nm or more. The deposition of the insulating layer 27 can enhance an insulation effect as compared with a conventional case where only either the insulating film 3 or the protective film 4 is deposited. With the enhanced insulating effect, as compared with the conventional semiconductor laser element 100, holes injected from the wire bonding electrode 18 can be more concentrated into the ridge part 19. Thereby, the semiconductor laser element 1 can prevent hole burning from occurring and can emit a stable transverse-mode laser beam. Furthermore, this prevention of the hole burning enables the semiconductor laser element 1 to also prevent kink from occurring.

Prevention of bulk deterioration, emission of a stable transverse-mode laser beam and prevention of kink can be confirmed also by the fact that as shown in FIGS. 6B and 6C, there is little disturbance in a laser beam output in FFP in the case of the deposition of the insulating layer 27 as compared with the case of the deposition of SiN only. In this way, in the semiconductor laser element 1, it is possible to prevent bulk deterioration, to emit a stable transverse-mode laser beam and to prevent kink. Further, as shown in FIGS. 6A and 6C, an FFP obtained in a case of depositing the insulating layer 3 and the protective layer 4 is substantially identical with an FFP obtained in a case of depositing GaAlAs. Accordingly, in the semiconductor laser element 1, it is possible to obtain an FFP substantially the same as in the case of GaAlAs deposition, and at the same time, it is possible to suppress thermal stress and to secure a larger difference between refractive indices as compared with the case of GaAlAs deposition, thereby emitting a high-power laser beam.

Laser beam output characteristics shown in FIG. 6C are obtained by depositing the insulating layer 3 comprising alumina. Disturbance in laser beam output characteristics shown in FIG. 6B is caused by thermal stress which acts on the p-type cladding layer 10. Accordingly, in the semiconductor laser element 1 depositing the insulating layer 3 containing alumina, as shown in FIG. 6C, there is no such disturbance in laser beam output characteristics, and an effect of suppressing stress which acts on the p-type cladding layer 10 has been achieved. Further, as a difference in thermal expansion coefficient becomes lower, thermal stress which acts on between substances at substantially the same temperatures becomes lower. Accordingly, the insulating layer 3 containing alumina can achieve an effect of suppressing compressive thermal stress which acts on the p-type cladding layer 10. Therefore, it is especially preferred that the difference in thermal expansion coefficient between the p-type cladding layer 10 and the insulating film 3 is 3.0×10⁻⁶/K or less, which is the difference in thermal expansion coefficient between the p-type cladding layer 10 and the insulating layer 3 containing alumina. However, the difference is not limited to lower than or equal to this value, and it is appropriate only if such thermal stress that may cause crystal defects on the active layer 9 does not act on the p-type cladding layer 10.

In this embodiment, described is the case where the thermal expansion coefficient of the insulating film 3 is higher than that each of the p-type cladding layer 10 and the protective film 4, the constitution is not necessarily limited to such a particular constitution. For example, in a case where the thermal expansion coefficient of the insulating film 3 is lower than those of the p-type cladding layer 10 and the protective film 4, a tensile thermal stress acts on the p-type cladding layer 10, and the protective film 4 thus causes compressive stress to apparently act on the p-type cladding layer 10, thereby relaxing the tensile thermal stress which acts on the p-type cladding layer 10.

In this embodiment, the semiconductor laser element 1 is constituted by a GaAlAs semiconductor laser element, but the constitution is not limited to such a particular one. For example, the semiconductor laser element may be a GaN semiconductor laser element or an AlGaInP semiconductor laser element. Furthermore, although the insulating film 3 and the protective film 4 are formed on the p-type cladding layer 10, only the insulating film 3 may be formed thereon. In this case., the thermal expansion coefficients of the p-type cladding layer 10 and the insulating film 3 are approximate to each other as mentioned above, it is possible to suppress compressive thermal stress or tensile thermal stress which occurs in the p-type cladding layer 10 and thereby to prevent bulk deterioration. It is, therefore, possible to make an emission lifetime of a laser beam longer than that of a conventional art. Since even only the insulating film 3 can lengthen an emission lifetime of a laser beam, it is possible to reduce the number of films obtained by causing crystal growth and to simplify the configuration. Production costs involved can thus be decreased. Even in a case where the thermal expansion coefficients of the p-type cladding layer 10 and the insulating film 3 are not approximate to each other, it is possible to relax thermal stress acting on the p-type cladding layer 10, by depositing the protective film 4 on the insulating film 3.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A semiconductor laser element comprising:
a compound semiconductor multilayer structure composed of at least a first cladding layer of a first conductivity type, an active layer, and a second cladding layer of a second conductivity type, which layers are deposited sequentially in one direction, the second cladding layer including a ridge part shaped in a stripe; and
an insulating film formed of an insulating material having a refractive index different from that of a material constituting the second cladding layer and a thermal expansion coefficient approximate to that of a material constituting the second cladding layer,
wherein the insulating film is deposited on the second cladding layer.

2. The semiconductor laser element of claim 1, wherein the insulating material is an alumina film.

3. The semiconductor laser element of claim 1, wherein the insulating film has a film thickness of 100 nm or more and 300 nm or less.

4. The semiconductor laser element of claim 1, further comprising:
a protective film deposited on the insulating film, for relaxing thermal stress which acts on the second cladding layer.

5. The semiconductor laser element of claim 4, wherein the protective film is formed of one of silicon oxide, silicon nitride and silicon.

6. The semiconductor laser element of claim 4, wherein the protective film has a film thickness of 100 nm or more and 300 nm or less.

7. A method of manufacturing a semiconductor laser element comprising:
a compound semiconductor multilayer structure manufacturing step of depositing a first cladding layer of a first conductivity type, an active layer and a second cladding layer of a second conductivity type, sequentially in one direction, and forming a ridge part shaped in a stripe on the second cladding layer; and
an insulating film forming step of forming an insulating film on the second cladding layer by depositing an insulating material having a refractive index different from that of a material constituting the second cladding layer and a thermal expansion coefficient approximate to that of a material constituting the second cladding layer.

8. The method of manufacturing a semiconductor laser element of claim 7, further comprising:
a protective film forming step of depositing on the insulating film a protective film for relaxing thermal stress which acts on the second cladding layer.
